(19) United States
(12) Patent Application Publication
(10) Pub. No.: US 2015/0275530 A1
(43) Pub. Date: Oct. 1, 2015

(54) WIND POWER PLANT AND WIND POWER PLANT TOWER

(71) Applicant: Wobben Properties GmbH, Aurich (DE)

(72) Inventors: Frank Pollmann, Aurich (DE); Alexander Gröss, Wittmund (DE)

(21) Appl. No.: 14/437,481

(22) PCT Filed: Oct. 22, 2013
(86) PCT No.: PCT/EP2013/072015

§ 371 Date: Apr. 21, 2015

(30) Foreign Application Priority Data
Oct. 22, 2012 (DE) 102012020687.9
May 13, 2013 (DE) 102013208760.8

(51) Int. Cl. E04G 3/28; F03D 11/04; E04H 12/34

(52) U.S. Cl. CPC E04G 3/28; E04H 12/342; F03D 11/04; E04G 2003/286

(57) ABSTRACT

There is provided a wind power installation comprising a pylon which has a plurality of pylon segments. Some of the pylon segments are made up from a plurality of pylon segment parts. The pylon segment parts are fixed together by way of screw connections. The wind power installation further has at least one guide cable extending at least partially along the length of the pylon. The wind power installation also has a working platform which can be fixed to the guide cable for guidance and which can be moved upwardly and downwardly by way of a travel cable. In that way the screw connections of adjacent pylon segment parts can be checked.

### BACKGROUND

1. Technical Field

The present invention concerns a wind power installation and a wind power installation pylon.

2. Description of the Related Art

The pylons of wind power installations are typically made up from various segments. The segments can be screwed together. The segments can also be braced together by tensioning cables.

DE 10 2010 005 991 A1 discloses a pylon of a wind power installation, wherein the pylon is made up of a plurality of segments or pylon stories. A pylon segment or story can comprise a plurality of parts. Those parts can be provided at the abutting surfaces with connecting bodies in the recesses in the pylon stories, the connecting bodies being used for connecting two parts of a pylon story.

The screw means at the pylon segments or stories have to be checked by maintenance personnel. In particular in a 300 h maintenance operation it can happen that the screw means are checked.

However checking those screw means is very time-consuming. When checking the screw connections in or on the pylon it is necessary to take account of the fact that the pylon of a wind power installation can be over 100 m high. In the case of the pylon of a wind power installation it can happen that the screw connections to be checked are remote from each other so that checking by maintenance personnel can be very complicated and expensive. For example, to maintain the screw connections, climbing ladders can be provided at the inside wall of the pylon. In addition platforms to stand on can be provided at the inside wall of the pylon.

### BRIEF SUMMARY

One or more embodiments of the present invention is directed to a wind power installation and a wind power installation pylon, which permit efficient checking of the screw means of the pylon stories.

In one embodiment there is provided a wind power installation comprising a pylon which has a plurality of pylon segments. Some of the pylon segments are made up from a plurality of pylon segment parts. The pylon segment parts are fixed together by way of screw connections. The wind power installation further has at least one guide cable extending at least partially along the length of the pylon. The wind power installation also has a working platform which can be fixed to the guide cable for guidance and which can be moved upwardly and downwardly by way of a travel cable. In that way the screw connections of adjacent pylon segment parts can be checked.

In an aspect of the invention the working platform has a counterweight which can be fixed to the travel cable.

In a further aspect of the invention the working platform is supplied with power by way of a voltage cable.

In an aspect of the invention the guide cables extend in the region of the screw connections of the pylon segment parts.

One embodiment of the invention is also directed to concerns a wind power installation pylon having a plurality of pylon segments. At least one pylon segment has a plurality of pylon segment parts. The pylon segment parts can be fixed together by way of screw connections. The pylon further has at least one guide cable extending at least partially along the length of the pylon. The pylon further has a working platform which can be fixed to the guide cable and which can be moved upwardly and downwardly by way of a travel cable to check screw connections of adjacent pylon segment parts.

According to one embodiment of the invention the pylon of the wind power installation has at least one pylon segment which is longitudinally divided, that is to say the pylon segment comprises a plurality of pylon segment portions or parts which are fitted together to form the pylon segment.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind power installation according to one embodiment of the invention,

FIG. 2 shows a diagrammatic sectional view of a pylon of a wind power installation according to a first embodiment,

FIG. 3 shows a diagrammatic view of a working platform of a first embodiment, and

FIG. 4 shows a diagrammatic view of a part of a pylon of a wind power installation according to a second embodiment.

### DETAILED DESCRIPTION

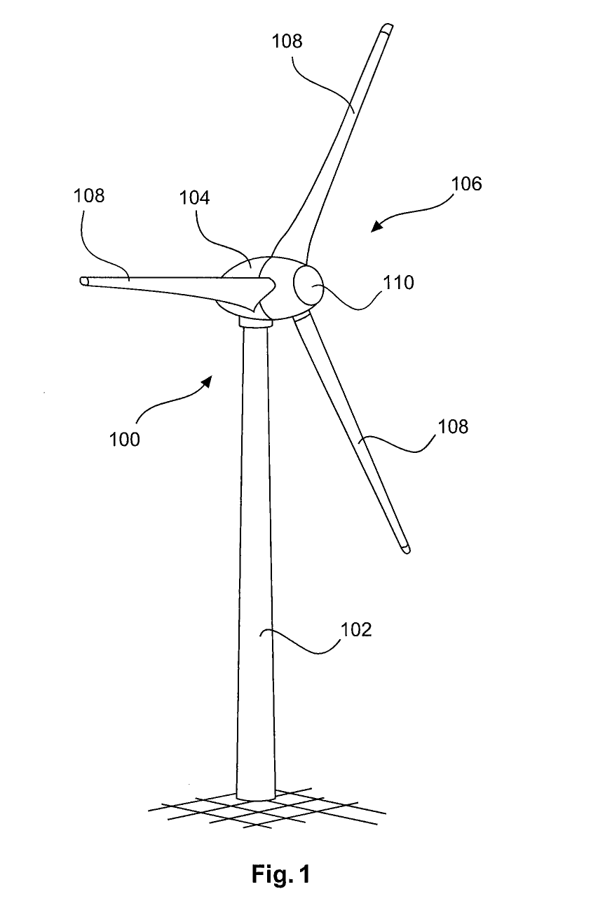

FIG. 1 shows a diagrammatic view of a wind power installation according to one embodiment of the invention. The wind power installation 100 has a pylon 102 and a pod 104. Provided on the pod 104 is a rotor 106 with three rotor blades 108 and a spinner 110. In operation the rotor 106 is caused to rotate by the wind and thereby also rotates the rotor or rotor member of the generator in the pod 104. The pitch angle of the rotor blades 108 can be altered by pitch motors at the rotor blade roots of the respective rotor blades 108.

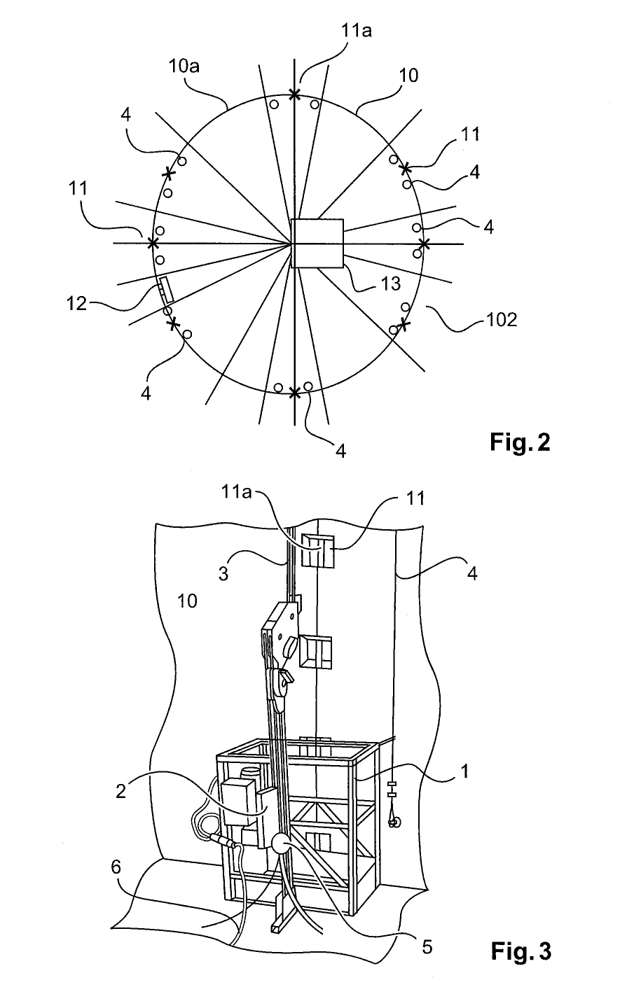

FIG. 2 shows a diagrammatic sectional view of a pylon of a wind power installation according to a first embodiment. The pylon 102 of the wind power installation has a pylon wall 10. The pylon 102 of the wind power installation comprises a plurality of pylon segments or pylon stories. Those pylon segments are placed one upon the other to form the pylon 102 of the wind power installation. Particularly in the lower region it can happen that a pylon segment is composed of a plurality of pylon segment parts 10a. The pylon segment parts 10a are fixed together at their abutting surfaces 11. The abutting surfaces 11 can have connecting screws 11a. The abutting surfaces extend in the longitudinal direction of the pylon. The connecting screws 11a of adjacent pylon segment parts 10a are fixed to each other by means of screw connections. Those screw connections have to be checked after the wind power installation is brought into operation, for example as a 300 h maintenance procedure.

The pylon 102 of the wind power installation can optionally have a personnel lift or a climbing aid 13 which is used by the maintenance personnel to get into the pod 104, for example for maintenance purposes. However it is not possible by means of that personnel lift or the climbing aid 13 to check the screw connections of the connecting screws 11a at the abutment locations 11.

At its inside wall the pylon 102 of the wind power installation also has a fixed climbing ladder 12 by means of which the maintenance personnel can also get into the pod of the wind power installation or into intermediate portions or intermediate platforms in the pylon 102 of the wind power installation. It is also not possible for the maintenance personnel, by means of that fixed ladder 12, to check all screw connections of the connecting screws 11a.

The screw connections of the connecting screws can also be in the form of screw boxes. Guide cables 4 can be provided in the region of the screw boxes or connecting screws. The guide cables 4 serve to guide a climbing aid or working platform shown in FIG. 3. The guide cables 4 can extend from the bottom of the pylon of the wind power installation or from an intermediate platform into the pylon head or as far as an intermediate platform fixed in one of the higher pylon segments. Alternatively or additionally thereto the upper ends of the guide cables 4 can also be fixed directly to the pylon wall. The guide cables 4 can optionally remain installed after erection of the pylon of the wind power installation and can also remain in the pylon after the 300 h maintenance procedure.

FIG. 3 shows a diagrammatic view of a working platform in a pylon of a wind power installation according to the first embodiment. A working platform 1 has a motor 2, by means of which the working platform 1 can be conveyed upwardly or downwardly along a travel cable 3. A counterweight 5 can be fixed to the travel cable 3. The working platform 1 can be supplied with power by way of a voltage cable 6.

A fitter or maintenance personnel can reach the respective screw connections to check them, by means of the working platform 1 or the climbing aid.

Accordingly fixed climbing ladders do not have to be also fixed at all locations where there are connecting screws or screw boxes 11a so that those screw connections can be maintained. Rather, it is only necessary to provide at least one guide cable 4 at the corresponding locations. The working platform 1 can be used again at the other locations of the screw boxes or connecting screws.

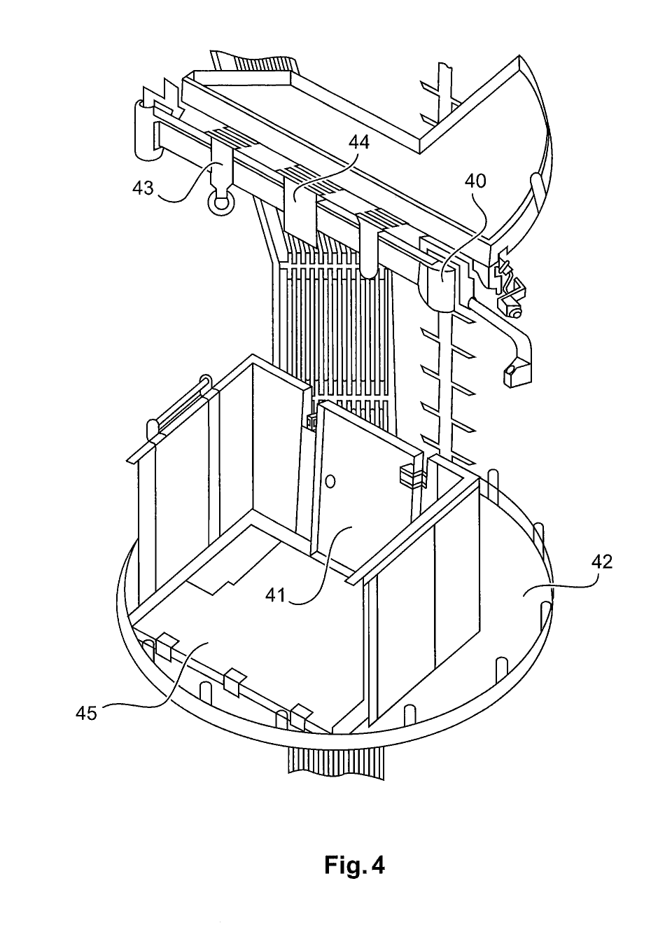

FIG. 4 shows a diagrammatic view of a part of a pylon of a wind power installation according to a second embodiment. The wind power installation of the second embodiment can be based on the wind power installation according to the first embodiment. FIG. 4 shows in particular a transverse portion 40 fixed within the pylon. In this case the guide cables 4 can be fixed to the transverse portion 40. For example the guide cables 4 and/or the travel cables 3 can be fixed to the outer ends of the transverse portion 40.

The structure in FIG. 4 also has a fixing unit 43 for fixing the personnel cage holder and a fixing unit 44 for fixing the lift holder to the transverse portion. In addition FIG. 4 shows an exit platform 42 and a lift exit in the pylon head 41 and a lift passage 45.

According to one or more embodiments of the invention at least one guide cable 4 is required for guiding the working platform. Optionally however it is also possible to use more than one guide cable.

Optionally the guide and/or travel cables can be fixed in or to the pylon of the wind power installation in such a way that the maintenance personnel can check all screw joins with the associated screw connections, in particular at the abutment locations of the pylon segment parts. As typically only the lower pylon segments comprise a plurality of pylon segment parts the guide and/or travel cables do not have to be extended to the pylon head. Optionally the travel and/or guide cables 3, 4 can be fixed to those pylon segments which are arranged above the pylon segment which is made up of a plurality of pylon segments.

All of the U.S. patents, U.S. patent application publications, U.S. patent applications, foreign patents, foreign patent applications and non-patent publications referred to in this specification and/or listed in the Application Data Sheet are incorporated herein by reference, in their entirety.

1. A wind power installation comprising:
a pylon including a plurality of pylon segments, wherein at least one pylon segment of the plurality of the pylon segments is made up from a plurality of pylon segment parts, wherein the pylon segment parts are fixed to each other by way of screw connections;
at least one guide cable inside the pylon and extending at least partially along a longitudinal length of the pylon; and
a working platform and a travel cable, the working platform being configured to be fixed to the at least one guide cable inside the pylon for guidance and moved upwardly and downwardly by way of the travel cable.

2. The wind power installation according to claim 1 wherein the working platform has a counterweight fixed to the travel cable.

3. The wind power installation according to claim 1 wherein the working platform is configured to move upwardly and downwardly by power received from a voltage cable.

4. The wind power installation according to claim 1 wherein the pylon segment parts have abutting surfaces that extend in a longitudinal direction of the pylon.

5. A wind power installation according to claim 1 wherein the at least one guide cable extends in the region of the screw connections of the pylon segment parts.

6. A wind power installation pylon comprising:
a plurality of pylon segments, wherein at least one pylon segment of the plurality of the pylon segments is made up from a plurality of pylon segment parts, wherein the pylon segment parts are fixed together by screw connections,
at least one guide cable extending at least partially along a longitudinal length of the pylon and located inside the pylon, and
a working platform and a travel cable, the working platform being configured to be fixed to the guide cable located inside of the pylon and to move upwardly and downwardly along the travel cable, to allow a person on the working platform to check the screw connections of adjacent pylon segment parts.

7. The wind power installation according to claim 6, wherein the at least one guide cable extends in the region of the screw connections of the pylon segment parts.

8. The wind power installation according to claim 6, wherein the travel cable has a counterweight fixed at its end.
